(19) United States
(12) Patent Application Publication
(10) Pub. No.: US 2007/0279653 A1
(43) Pub. Date: Dec. 6, 2007

(54) Generation and printing of a customized maintenance manual utilizing current machine status

(75) Inventor: Gregg A. Bonikowski, Rochester, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 11/444,706

(22) Filed: Jun. 1, 2006

(51) Int. Cl. H04N 1/60

(52) U.S. Cl. 358/1.9

(57) ABSTRACT

A method and system for rendering a customized maintenance manual. A machine can be automatically analyzed to identify one or more particular activities necessary for servicing the machine. Thereafter, a customized maintenance manual can be generated in response to a particular user input, wherein the customized maintenance manual includes only the identified particular activities necessary for servicing the machine, thereby resulting in a reduction of non-productive user time spent on maintenance activities associated with the machine.

### TECHNICAL FIELD

Embodiments are generally related to data-processing systems and rendering devices, such as printers, photo-copy machines, scanners, fax machines and the like. Embodiments also relate to the servicing of rendering devices or reproduction machines. Embodiments additionally relate to method and systems for generating and printing customized maintenance manuals.

### BACKGROUND OF THE INVENTION

As reproduction machines such as copiers and printers become more complex and versatile in the jobs which they can perform, the servicing of such reproduction machines also becomes more complex. These reproduction machines include numerous subcomponents, each of which contributes to some operation of the reproduction machine. In accordance with the types of operations preferably performed by a particular reproduction machine, the initial set-up of the machine varies. Accordingly, identical reproduction machines can initially be provided with widely varying set-up features.

Due to the complexity of the reproduction machine, numerous tasks are often required of service representatives as machines malfunction and are diagnosed and corrected. Troubleshooting can involve numerous servicing procedures to isolate malfunctioning machine subcomponents. Service representatives must, therefore, keep track of servicing procedures previously performed in order to isolate the source of any machine malfunction.

Periodic maintenance is required for all production and many office printing systems. Such systems typically define a set of High Frequency Service Items (HFSIs), which outline various maintenance activities that must be performed at different intervals. These systems also employ internal sensors and counters to determine which of the HFSI's require servicing at a particular time. The status of these HFSIs is presented on request to the operator.

For any HFSI that requires attention, there is typically a hardcopy or online maintenance manual that details the specific procedure for servicing that item. When performing periodic maintenance, the operator typically opens a GUI on the printer that details current HFSI status, determines the next HFSI that requires attention, looks up the appropriate maintenance procedure for each HFSI in the manual, performs the specified maintenance procedure, and repeats the above steps for the next HFSI. The time spend on periodic maintenance is non-productive overhead. The present invention reduces the non-productive time spent on daily maintenance activities and minimizes amount of time spend on each activities.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide an improved method for servicing a reproduction or rendering machine.

It is another aspect of the present invention to provide a method for generating and printing a customized maintenance manual utilizing a current machine status.

The aforementioned aspects and other objectives and advantages can now be achieved as described herein. A method and system is disclosed for rendering a customized maintenance manual. In general, a machine (e.g., a rendering device) can be automatically analyzed to identify one or more particular activities necessary for servicing the machine. Thereafter, a customized maintenance manual can be generated in response to a particular user input, wherein the customized maintenance manual includes only the identified particular activities necessary for servicing the machine, thereby resulting in a reduction of non-productive user time spent on maintenance activities associated with the machine.

Additionally, a plurality of activities necessary for servicing the machine can be arranged an order deemed most productive for the maintenance of the machine. These activities can then be performed. Thereafter, the customized maintenance manual can be discarded after completion of the maintenance of the machine, or maintained as a record of maintenance actions that were performed. A new customized manual can then be generated for the next maintenance session, in response to a subsequent user input.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a data-processing system, which can be utilized for the generation and printing of a customized maintenance manual utilizing current machine status, in accordance with a preferred embodiment;

FIG. 2 illustrates a high level flowchart of operations depicting logical operational steps for the generation and printing of a customized maintenance manual, in accordance with an preferred embodiment;

FIG. 3 illustrates a front view of a reproduction machine interface for selecting an option associated with generation of the maintenance manual, in accordance with a preferred embodiment;

FIG. 4 illustrates a front view of a reproduction machine interface for printing or displaying maintenance manual, in accordance with a preferred embodiment; and

FIG. 5 illustrates a front view of a reproduction machine interface showing optimal maintenance steps, in accordance with a preferred embodiment.

### DETAILED DESCRIPTION

The particular values and configurations discussed in these non-limiting examples can be varied and are cited merely to illustrate at least one embodiment and are not intended to limit the scope thereof.

The embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type.

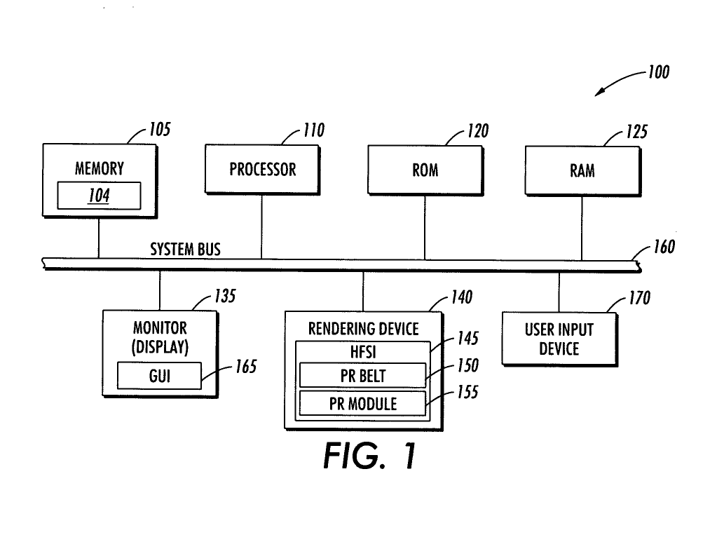

Software modules generally include instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and recordable media. An example of such a module is module 104 depicted in FIG. 1.

It is important to note that, although the embodiments are described in the context of a fully functional data-processing apparatus (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Referring to the drawings and in particular to FIG. 1, there is depicted a data-processing apparatus 100 for the generation and printing of a customized maintenance manual utilizing a current machine status (e.g., a computer and reproduction machine) in accordance with a preferred embodiment. As shown in FIG. 1, a memory 105, a processor (CPU) 110, a Read-Only memory (ROM) 120, and a Random-Access Memory (RAM) 125 are generally connected to a system bus 160 of data-processing apparatus 100. Memory 105 can be implemented as a ROM, RAM, a combination thereof, or simply a general memory unit. Module 104 can be stored within memory 105 and then retrieved and processed via processor 110 to perform a particular task. A user input device 170, such as a keyboard, mouse, or another pointing device, is also connected to and communicates with system bus 106.

Depending upon the design of data-processing apparatus 100, memory 105 may be utilized in place of or in addition to ROM 120 and/or RAM 125. A monitor 135 can also be connected to system bus 160 and can communicate with memory 105, processor 110, ROM 120, RAM 125 and other system components. Monitor 135 generally functions as a display for displaying data and information for a user and for interactively displaying a graphical user interface (GUI) 165. A rendering device or reproduction machine 140 is also connected to system bus 160 and can generate a customized maintenance manual containing the contents required for the HFSIs 145 (e.g., a Photoreceptor (PR) belt 150 and a PR module 155) to be served as will be described in greater detail herein. The rendering device or reproduction machine 140 can be implemented as provided as a rendering device, such as, for example, a laser jet printer, a photocopy machine, a fax machine, a scanner, and so forth, depending upon design considerations.

Note that the term “GUI” generally refers to a type of environment that represents programs, files, options and so forth by means of graphically displayed icons, menus, and dialog boxes on a computer monitor screen. A user can interact with the GUI to select and activate such options by pointing and clicking with a user input device such as, for example, a pointing device such as a mouse, and/or with a keyboard. A particular item can function in the same manner to the user in all applications because the GUI provides standard software routines (e.g., module 104) to handle these elements and reports the user's actions.

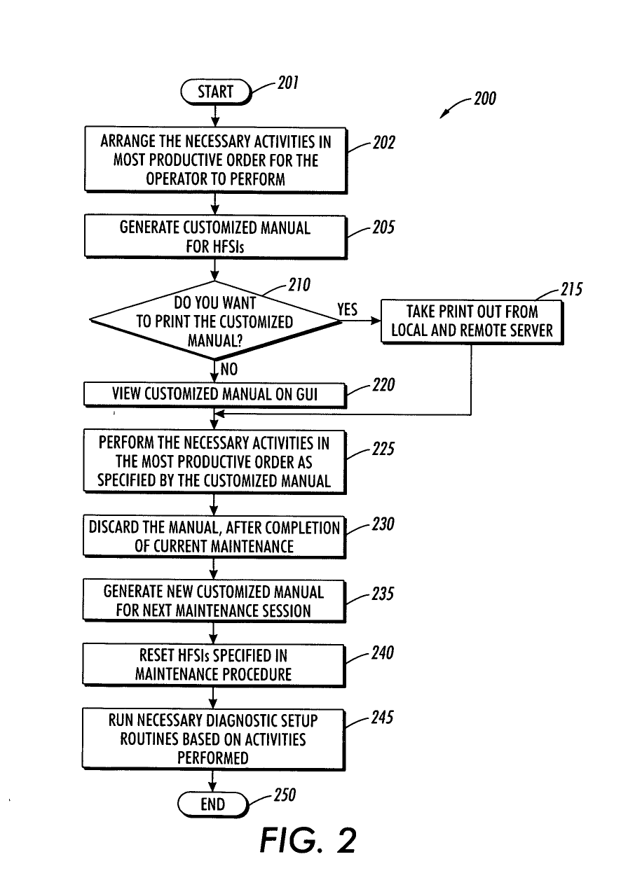

Referring to FIG. 2, a high level flowchart 200 is illustrated, which describes the generation and printing of a customized maintenance manual, in accordance with a preferred embodiment. Note that the process or method described in flow chart 200 of FIG. 2 can be implemented in the context of a software module, such as module 104 of data-processing apparatus 100 depicted in FIG. 1. A generation and printing process can begin as indicated at block 201. As said at block 202, the necessary activities that an operator has to perform are arranged in most productive order. A reproduction machine, such as the reproduction machine 140 depicted in FIG. 1, can generate a customized maintenance manual containing only the content required for the HFSI's to be serviced as depicted at block 205.

As described next at block 210, a test can be performed to determine if a rendering operation (e.g. printing) should be performed. The user can display or print the customized maintenance manual, depending upon the outcome of the test illustrated at block 210. If the user desires to print the manual, then as indicated at block 215, the user can print the manual using a local or remote reproduction machine. If, however, the user does not desire to print the manual, the user can view the manual using a GUI (e.g., GUI 165 of FIG. 1), as depicted at block 220.

After displaying or printing the manual, as described at block 225, the operator performs the necessary maintenance activities arranged in the most productive order as specified by customized manual. Thereafter as described at block 230, the manual can be discarded after the current maintenance operations are complete, and a new customized manual generated for the next maintenance session as indicated thereafter at block 235. The ‘Maintenance Manual’ GUI allows the operator to reset the HFSIs specified in the procedure, either collectively or individually as described next at block 240, as well as running any necessary diagnostic setup routines based on the activities performed as illustrated thereafter at block 245. The process can then end, as indicated at block 250.

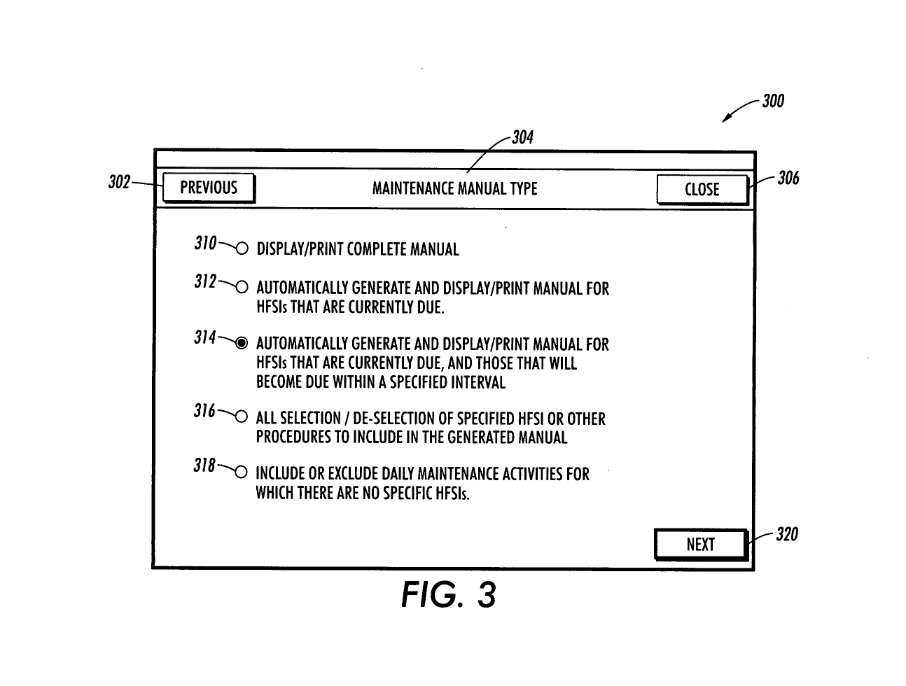

Referring to FIG. 3, a front view of a reproduction machine GUI window 300 for selecting an option associated with generation of a maintenance manual is illustrated, in accordance with a preferred embodiment. Note that GUI window 300 can be implemented utilizing a GUI such as the GUI 165 depicted in FIG. 1 and can be provided by a module, such as, for example, module 104. GUI window 300 can be displayed via a display device such as monitor 135 depicted in FIG. 1. Note that a GUI “window” as utilized herein generally constitutes a portion of a monitor screen that contains its own document or message. Such a window can display a number of options, icons, buttons, menus, dialog boxes, and so forth, such as, for example, icons 302, 304, 306 and/or 320. By “clicking” icon 302 with a pointing device such as a “mouse”, the user can view a prior “page”. By clicking icon 306, a user can close out the currently displayed window. Icon 304 can functions simply as a header with information such as “Maintenance Manual Type”.

A plurality of radio buttons 310, 312, 314, 316, and 318 can also be displayed within GUI window 300. Note that in GUI environments, a “radio button” can be graphically displayed for permitting a user to select one of several options, typically within a dialog box of some sort. A radio button appears as a small circle that, when selected by a user, has a smaller, filled circle within it. Radio buttons act in a manner that is analogous to the station selector buttons on a car radio. Selecting one button on a set can deselect the previously selected buttons, so that one and only of the options in the set can be selected at any particular time.

Utilizing a GUI window 300, a user can select from among a number of options associated with generation of a maintenance manual. By selecting button 310, for example, a user can display and/or print the completed manual. By selecting button 312, a user can automatically generate and display/print manual for HFSIs that are currently due. By selecting button 314 a user can, automatically generate and display/print manual for HFSIs that are currently due, and those that will become due within a specified interval. Additionally, by selecting button 316, a user can allow for the selection and/or de-selection of specific HFSI or other procedures to include the in the generated manual. Finally, by selecting button 316, a user can include or exclude daily maintenance activities (e.g. cleaning) for which there are no specific HFSIs. Note that by “clicking” icon 320, a user can activate the display of another GUI window, such as, for example, GUI window 400, which is described below in more detail.

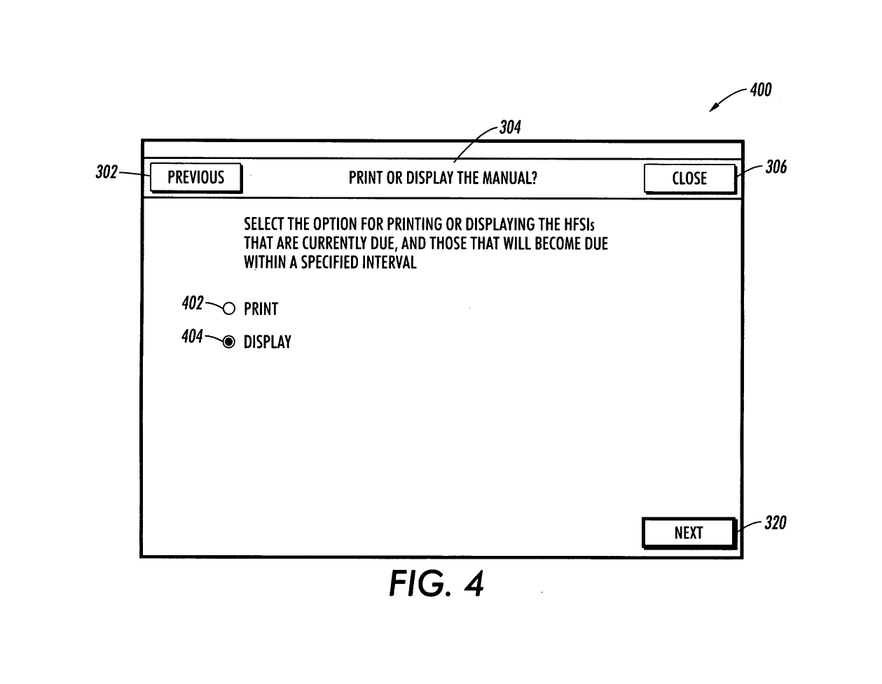

Referring to FIG. 4, a front view of a reproduction machine GUI window 400 for printing or displaying a maintenance manual is illustrated, in accordance with a preferred embodiment. Note that in FIGS. 3-5, identical or similar parts or elements are indicated by identical reference numerals. Thus, GUI window 400 also contains the graphically displayed icons, 302, 304, 306, and 320. GUI window 400 also contains, however, radio buttons 402 and 404, which are not displayed in GUI window 300 depicted in FIG. 3. GUI window 400 permits the maintenance manual to be displayed or printed according to one of the options selected in the FIG. 3. For example, by selecting a radio button 402, the maintenance manual can be printed. By selecting radio button 404, the maintenance manual can be displayed within a display screen of a monitor (e.g., monitor 165 depicted in FIG. 1). It can be appreciated that the aforementioned GUI design represents merely one example of how the embodiments can be implemented, and the scope of the embodiment can be implemented in the context of other designs, including non-GUI implementations.

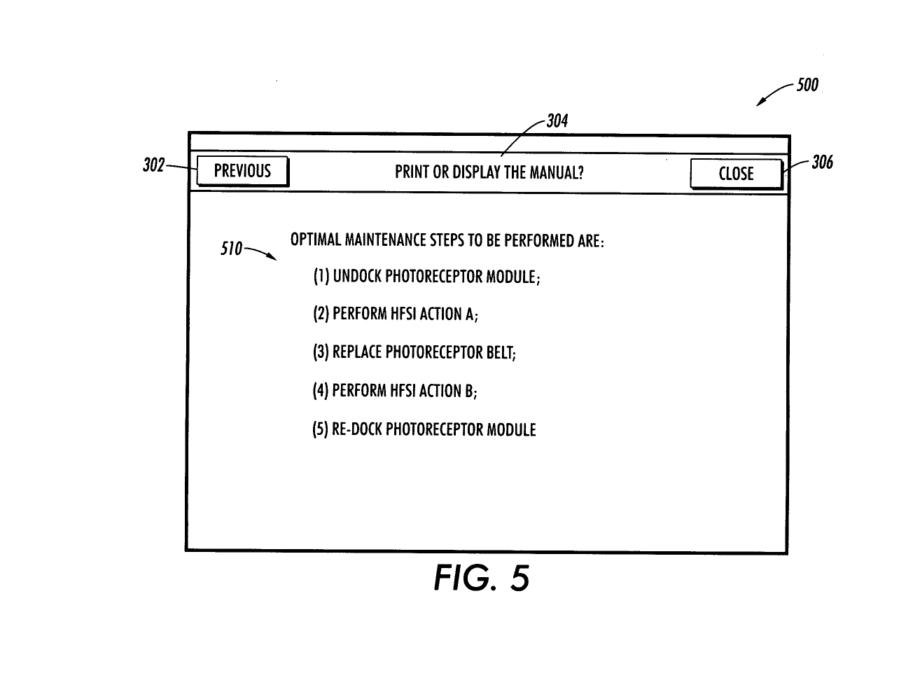

Referring to FIG. 5, a front view of a reproduction machine GUI window 500 showing optimal maintenance steps 510 is depicted, in accordance with a preferred embodiment. Again, as indicated earlier, identical parts of elements depicted in FIGS. 3-5 are generally indicated by identical reference numerals. When the manual is generated, the necessary activities can be arranged in the most productive order for the operator to perform, by grouping the activities by the machine areas that must be accessed. The overall procedures themselves can be optimized by grouping activities that have common preparation steps. For example assume three HFSIs are due. One is replacement of the photoreceptor belt; two are cleaning of devices that require undocking of the photoreceptor module.

Typical maintenance manuals can document each of these procedures individually, with each including (references to) instructions for initially undocking the photoreceptor module, and re-docking the module at the end of the procedure. The set of actions to be performed, the most optimal sequence can be documented for this specific case without repeated activities are undock PR module, perform HFSI action A, replace PR belt, perform HFSI action B, re-dock PR module, etc. By utilizing knowledge of the ideal sequencing of maintenance procedures, operators can always be presented with an optimized sequence of steps that minimizes both repeated actions and overall maintenance time.

Once the manual is generated, and the necessary maintenance actions have been completed, the ‘Maintenance Manual’ GUI allows the operator to reset the HFSIs specified in the procedure, either collectively or individually, as well as running any necessary diagnostic setup routines based on the activities performed.

By implementing the method and system disclosed herein, a reproduction machine can be utilized to generate a customized maintenance manual containing only the content required for the HFSIs to be serviced. This customized manual can be viewed on a GUI, or can be printed on a local or remote reproduction machine for reference. If printed, the manual can be discarded after the current maintenance operations are completed, and a new customized manual generated for the next maintenance session. The disclosed embodiments allow for GUI-based actions required as a part of maintenance procedures (such as resetting HFSIs) to be performed directly from the generated customized manual.

The primary focus of such embodiments is the reduction of non-productive time spent on daily maintenance activities. This can be accomplished by providing an operator with a customized list of only those activities that must be performed, along with detailed instructions for performing each activity. Time is therefore saved because the operator does not need to continuously navigate between the HFSI status list displayed at the reproduction machine GUI and a general hardcopy maintenance manual. Time is also saved by optimizing the sequence of operations to be performed based on the specific procedures required in each maintenance session. The overall quality of the maintenance performed may also be improved, by providing the operator with easy access to the detailed maintenance procedures, reducing the chance that they will attempt to perform the procedures “from memory” rather than taking the time to search out a frequently-performed procedure in the manual. Improving the quality of daily maintenance procedures can reduce subsequent system downtime for reliability or image quality problems, and potentially avoid unscheduled service calls.

A key feature of the embodiments involves an existing machine state to produce an optimized use-once service recipe. This can make a big difference if a user needs to perform two maintenance operations, as the steps could be melded together in most efficient sequence. Such embodiments are most useful for inexperienced users (hence compatible with trend toward more customer-performed maintenance) and applicable to any type of maintenance (e.g., auto, aircraft, etc).

A primary advantage involves maximizing the overall available productive time of a machine, resulting in more billable clicks. This represents one advantage to the provider of the machine. An advantage to the end user or customer is a higher net productivity, which provides a greater return on their printing and rendering assets. Additional advantages may include reduced service calls due to better overall machine maintenance. The contribution of reduced daily maintenance time to overall system productivity is also another advantage.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for rendering a customized maintenance manual, comprising:
analyzing a machine to identify at least one particular activity necessary for servicing said machine based on a current state of said machine; and
generating a customized maintenance manual in response to a particular user input, wherein said customized maintenance manual includes said at least one particular activity necessary for servicing said machine, thereby resulting in a reduction of non-productive user time spent on maintenance activities associated with said machine.

2. The method of claim 1 further comprising permitting a user to specify at least one action for inclusion with said customized maintenance manual.

3. The method of claim 1 further comprising automatically arranging a plurality of activities necessary for servicing said machine in a most productive order.

4. The method of claim 1 further comprising automatically generating a new customized manual for a next maintenance session, in response to a subsequent user input.

5. The method of claim further 1 comprising:
automatically arranging a plurality of activities necessary for servicing said machine in a most productive order; and
automatically generating a new customized manual for a next maintenance session, in response to a subsequent user input.

6. The method of claim 1 further comprising:
automatically arranging a plurality of activities necessary for servicing said machine in a most productive order;
performing said plurality of activities;
discarding said customized maintenance manual after completion of a maintenance of said machine; and
generating a new customized manual for a next maintenance session, in response to a subsequent user input.

7. A system for rendering a customized maintenance manual, comprising:
a data-processing apparatus;
a module executed by said data-processing apparatus, said module and said data-processing apparatus being operable in combination with one another to:
analyze a machine to identify at least one particular activity necessary for servicing said machine based on a current state of said machine; and
generate a customized maintenance manual in response to a particular user input, wherein said customized maintenance manual includes said at least one particular activity necessary for servicing said machine, thereby resulting in a reduction of non-productive user time spent on maintenance activities associated with said machine.

8. The system of claim 7 wherein said data-processing apparatus and said module are further operable in combination with one another to permit a user to specify at least one action for inclusion with said customized maintenance manual.

9. The system of claim 7 wherein said data-processing apparatus and said module are further operable in combination with one another to automatically arrange a plurality of activities necessary for servicing said machine in a most productive order.

10. The system of claim 7 wherein said data-processing apparatus and said module are further operable in combination with one another to automatically generate a new customized manual for a next maintenance session, in response to a subsequent user input.

11. The system of claim further 7 wherein said data-processing apparatus and said module are further operable in combination with one another to:
automatically arrange a plurality of activities necessary for servicing said machine in a most productive order; and
automatically generate a new customized manual for a next maintenance session, in response to a subsequent user input.

12. The system of claim wherein said data-processing apparatus and said module are further operable in combination with one another to:
automatically arrange a plurality of activities necessary for servicing said machine in a most productive order;
permit said user to perform said plurality of activities;
permit said user to discard said customized maintenance manual after completion of a maintenance of said machine; and
generate a new customized manual for a next maintenance session, in response to a subsequent user input.

13. A program product residing in a computer for rendering a customized maintenance manual, comprising:
instruction media residing in a computer for analyzing a machine to identify at least one particular activity necessary for servicing said machine based on a current state of said machine; and
instruction media residing in a computer for generating a customized maintenance manual in response to a particular user input, wherein said customized maintenance manual includes said at least one particular activity necessary for servicing said machine, thereby resulting in a reduction of non-productive user time spent on maintenance activities associated with said machine.

14. The program product of claim 13 further comprising instruction media residing in a computer for permitting a user to specify at least one action for inclusion with said customized maintenance manual.

15. The program product of claim 13 further comprising instruction media residing in a computer for automatically arranging a plurality of activities necessary for servicing said machine in a most productive order.

16. The program product of claim 13 further comprising instruction media residing in a computer for automatically generating a new customized manual for a next maintenance session, in response to a subsequent user input.

17. The program product of claim further 13 comprising:
instruction media residing in a computer for automatically arranging a plurality of activities necessary for servicing said machine in a most productive order; and
instruction media residing in a computer for automatically generating a new customized manual for a next maintenance session, in response to a subsequent user input.

18. The program product of claim 13 further comprising:
instruction media residing in a computer for automatically arranging a plurality of activities necessary for servicing said machine in a most productive order;
instruction media residing in a computer for permitting a user to perform said plurality of activities;
instruction media residing in a computer for permitted said user to discard said customized maintenance manual after completion of a maintenance of said machine; and
instruction media residing in a computer for generating a new customized manual for a next maintenance session, in response to a subsequent user input.

19. The program product of claim 18 wherein each of said instruction media comprises signal bearing media.

20. The program product of claim 19 wherein said signal bearing media comprises transmission media or recordable media.
